(19) United States
(12) Patent Application Publication
(10) Pub. No.: US 2023/0002276 A1
(43) Pub. Date: Jan. 5, 2023

(54) CARBON NEGATIVE CONCRETE PRODUCTION THROUGH THE USE OF SUSTAINABLE MATERIALS

(71) Applicant: HeroSand, LLC, Leander, TX (US)

(72) Inventors: Ian Mitchell, Bartlesville, OK (US); Robert W. Dillard, III, Austin, TX (US)

(73) Assignee: HeroSand, LLC, Leander, TX (US)

(21) Appl. No.: 17/856,325

(22) Filed: Jul. 1, 2022

Related U.S. Application Data
(60) Provisional application No. 63/218,009, filed on Jul. 2, 2021.

(51) Int. Cl. C04B 7/26; C04B 7/02; C04B 14/02; C04B 14/06; C04B 14/38

(52) U.S. Cl. CPC C04B 7/26; C04B 7/02; C04B 14/026; C04B 14/06; C04B 14/38; C04B 2103/20

(57) ABSTRACT

The present invention relates to additives and, more specifically, the use of biochar, in concrete and other cementitious materials to provide for building materials that have a lower carbon footprint than their traditional counterparts. Traditional methods for production of cement produce large amount of carbon dioxide (CO2). When coupled with the massive demand for cement building materials around the world, this means that the cement production has a significant impact on the amount of CO2 produced globally. By including biochar and other additives along with, or instead of some traditional components of cement, one may be able to provide for cementitious building materials that sequester carbon, rather than release it.

### PRIORITY STATEMENT UNDER 35 U.S.C. § 119 & 37 C.F.R. § 1.78

This non-provisional application claims priority based upon prior U.S. Provisional Patent Application Ser. No. 63/218,009, filed Jul. 2, 2021, in the names of Ian Mitchell and Robert W. Dillard, entitled “CARBON NEGATIVE CONCRETE PRODUCTION THROUGH THE USE OF SUSTAINABLE MATERIALS” the disclosures of which are incorporated herein in their entirety by reference as if fully set forth herein.

### FIELD OF THE INVENTION

The present invention relates to additives in concrete to mitigate or negate carbon dioxide (CO₂) emissions and, more specifically, the use of biochar, which is a high-carbon residue, such as that produced through a low-oxygen pyrolytic process, as a concrete additive.

### BACKGROUND OF THE INVENTION

Concrete is a major contributor to the climate crisis because its production releases huge quantities of carbon dioxide into the atmosphere, and carbon dioxide is one of the greenhouse gases most responsible for global warming. The carbon dioxide emissions from the production of concrete are so high that if concrete were a country, it would be the third-largest emitter of CO₂ behind China and the United States.

Concrete is the most widely used artificial material in existence and it currently accounts for about 8 percent of the carbon dioxide being emitted into the atmosphere dwarfing, for example, the aviation industry's contribution of 2.5 percent. Concrete's contribution of CO₂ is comparable to the entire agriculture industry, which is responsible for at least 8 percent of total carbon emissions.

The central ingredient in concrete is cement, which is made by crushing limestone and clay and adding iron ore or ash. The mixture is heated in a kiln to more than 2,600 degrees Fahrenheit. When heated, the calcium carbonate in limestone breaks into calcium oxide and carbon dioxide, which is released into the air. The calcium oxide is ground with limestone and gypsum to make cement. Half of the CO₂ emissions in the production of concrete come from the reaction that breaks up the calcium carbonate and the other half from the fossil fuels required to heat the kilns and transport the materials.

By way of example, we can calculate the amount of carbon dioxide released in the production of one mile of a two-lane road that is 24 feet wide and 1 foot thick can be calculated by first calculating the volume of total concrete as 1×24×5,280=126,720 cubic feet.

One cubic foot of concrete weighs 150 pounds, so the concrete in the two-lane road weighs 126,720×150=19 million pounds.

According to the National Ready Mixed Concrete Association, each pound of concrete releases 0.93 pounds of carbon dioxide during production. Therefore, the CO₂ released in the construction of a single mile of a two-lane road is 0.93×19 million=17.67 million pounds of carbon dioxide.

There is a need, therefore, for a method and system of producing concrete which reduces or eliminates the production of CO₂.

### DESCRIPTION OF THE DRAWINGS

For a more complete understanding of the present invention, and the advantages thereof, reference is now made to the following descriptions taken in conjunction with the accompanying drawings, in which:

FIG. 1 shows Table 1, wherein a control mixture of concrete is compared against a similar concrete wherein biochar has been used to replace a portion of the sand used in the control mix.

FIG. 2 shows Table 2, comparing the compressive strength of various formulations of the cementitious biochar material and a control mixture after a set drying period.

### DETAILED DESCRIPTION OF THE INVENTION

Biochar is a stable solid that is rich in carbon and can endure for thousands of years. Presently, Biochar is primarily used for its soil health benefits. Discussed herein is the use of biochar in cementitious mixtures, such as cement, plaster, stucco, and concrete to provide for improved, ecologically friendly, building materials.

Biochar is a high-carbon, fine to medium-grained residue formed via pyrolysis. Pyrolysis, or direct thermal decomposition of biomass in the absence of oxygen (preventing combustion), produces a mixture of solids (the biochar proper), liquid (bio-oil), and gas (syngas) products. The specific yields from pyrolysis are dependent on process conditions, such as temperature, residence time, and heating rate. These parameters can be optimized to produce various properties in the biochar in addition to regulating the percentage of each solid, liquid, or gas phase that is created.

When creating solid char from biomass, currently, the highest yield is attained when the temperatures are in the range of 400-500° C. (673-773° K). Pyrolysis occurs more quickly at the higher temperatures, typically requiring seconds rather than hours, but the increase in temperature decreases the yield of solid biochar. Therefore, a slow pyrolytic is generally better for the creation of biochar proper. Typical yields are roughly 35%.

In addition to the end cementitious product incorporating the biochar being carbon sequestering, it is contemplated that the process of making the biochar, may be improved to be more self-sustaining and carbon neutral.

Modern pyrolysis plants can be powered using the syngas created by the pyrolisation process and output 3-9 times the amount of energy required. As mentioned above, half of the CO₂ emissions in the production of concrete come from the reaction that breaks up the calcium carbonate and the other half from the fossil fuels required to heat the kilns and transport the materials. Therefore, powering pyrolysis plants using the syngas created by the pyrolisation process can help serve to significantly reduce the amount of CO₂ emissions in the production of concrete.

As a person skilled in the art will be aware, the compositions of concrete and cement, as well as the relative amounts of their constituent components can vary significantly depending on the desired characteristics of the material.

In embodiments, the aggregate in a mixture may be eliminated to the extent that the resultant media is a carbon negative.

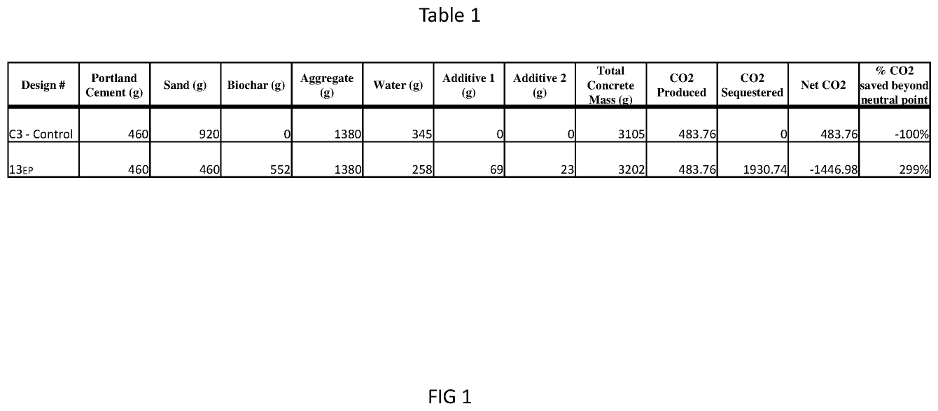

Referring now to FIG. 1, see Table 1, wherein a control concrete design mix compared is to an embodiment of the design mix of the present invention. The mixture of that embodiment discussed in Table 1 comprises Portland cement, sand, biochar, aggregate, water, and two additives, all in the respective amounts shown in the table. Additive 1 may be, for example, silica fume and Additive 2 may be, for example, poly-fiber.

As will be appreciated by those skilled in the art, the biochar mixture shown in Table 1 uses 50% less sand, 25% less water, and sequesters 299% of the carbon dioxide as compared to the normal concrete control mix, C3. Accordingly, for every cubic yard of such an embodiment of biochar concrete used 18,342 pounds of CO2 is sequestered.

When referring to the amount of CO2 saved beyond the neutral point, this assumes that normal concrete, such as the C3 control, accounts for 8% of total global CO2 emissions as discussed above. In other words, implementation of this embodiment of the present invention in place of its traditional counterpart could negate not only that 8%, making the entire process carbon neutral, and but would work to offset a further ˜24% of the worldwide CO2 emissions, thereby accounting for a net reduction of emissions by approximately 32%, or roughly ⅓ of global carbon emissions.

It should be importantly noted that the addition of biochar to a concrete mixture need not reduce the compressive strength and may, in fact, result in a significant increase in compressive strength.

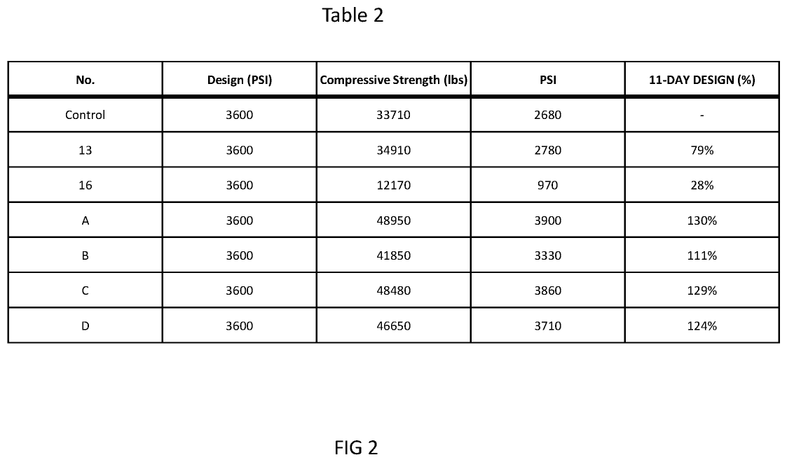

The strength of concrete can be determined experimentally by a test wherein a mixture is used to make two cylinders, the compressive strength of which are tested until failure after 7 and 28 days of drying, respectively. This tells you the relative compressive strength of the formulation's end product, and how that strength is affected by the drying process. Referring now to FIG. 2. Table 2 a comparison of the compressive strength for a control mix without biochar compared to a number of similar mixtures comprising different amounts of biochar and other additives. In test corresponding to Table 2, the test was performed first with the control mix and then all of the other tests were normalized using the 2680 PSI number achieved through the standard control mix design.

The preparations of biochar mixtures in Table 2 correspond to the formulas presented below:

Mix 13
1.0 units cement
1.0 units sand
1.2 units biochar
3.0 units aggregate
1.0 units water

Mix 16
1.0 units cement
1.0 units sand
1.5 units biochar
3.0 units aggregate
1.0 units water

Mix “A”
1.0 units cement
1.0 units sand
1.2 units biochar
3.0 units aggregate
0.875 units water

Mix “B”
1.0 units cement
1.0 units sand
1.2 units biochar
3.0 units aggregate
0.875 units water
0.06 units silica fume

Mix “C”
1.0 units cement
1.0 units sand
1.2 units biochar
3.0 units aggregate
0.875 units water
0.08 units poly fiber

Mix “D”
1.0 units cement
1.0 units sand
1.2 units biochar
3.0 units aggregate
0.875 units water
0.004 units graphene

Although not described in the mixtures hereinabove, it is contemplated that biochar may be used not only to supplement; but, depending on the requirements of its application, to entirely replace the sand and/or aggregate traditionally included in such mixes.

As the standard components of a cementitious material may be varied across mixes according to the desired properties of their respective end-products, so too may the type(s) and amount(s) of additives, including non-standard additives like biochar, be varied in to effect the desired properties of their respective end products.

Embodiments may comprise between about 10% and about 12% fly ash, by weight of concrete.

Embodiments may comprise between about 8% and about 16% finely ground anhydrous calcium sulfate, by weight of concrete.

Embodiments may comprise between about 2% and about 12% silica fume by weight of concrete, to increase their compressive strength.

Embodiments may comprise between about 1.5% and about 4.5% fibers, by weight of concrete, to provide added strength. These fibers may be made of fiberglass, bagasse, steel, glass, polypropylene, carbon fiber, Kevlar, or other similar media.

Embodiments may comprise between about 0.01% and about 3% graphene, by weight of concrete, to increase their compressive strength. The graphene referenced herein may be derived from a sustainable source of organic molecules.

Embodiments may comprise between about 0.1% and about 3% carbon molecules in nanotubular configurations, by weight of concrete, to increase their compressive strength.

Embodiments may comprise between about 0.1% and about 3% carbon molecules in one or more fullerene configurations, as measured by weight of concrete, to increase their compressive strength. Such carbon fullerenes may range from C20:C54 and from C-70:C-360 and may operate to increase the compressive strength of the mixture by filling small voids and having Van Der Waals' interaction in the intramolecular spaces between other components of the mixture.

One exemplary use case for embodiments of the cementitious mixtures contemplated herein would be to provide a carbon-conscious alternative current oil field well cement, such as for use in encasing down hole well piping and/or for the plugging oil field wells that have been/are being decommissioned.

Embodiments of such mixtures may be tailored to best fit the specific application at hand. The biochar-containing material may be formulated to be, for example, more flowable than its conventional counterparts, and as such it may be preferentially used in environments where pumping is required. Such tailoring may be dependent on a plurality of relevant variables, such as, for example, the local environment and the depth of the well in which the material is to be used.

Embodiments may comprise between about 2% and about 5.5% accelerant(s), by weight of concrete, to offset the setting delays produced from the addition of dispersants and fluid loss control agents frequently used in oil and gas well cement. Accelerant(s) may include, for example, both regular and/or anhydrous calcium chloride (CaCl2).

Embodiments may comprise between about 2% and about 2.5% partial accelerant(s), by weight of concrete, to offset the setting delays produces from the addition of such dispersants and fluid loss control agents. Partial accelerants may include, for example, sodium chloride (NaCl).

Embodiments may comprise between about 0.1% and about 1.0% retardant(s) by weigh, to prevent flash setting due to increased thermal loading, increased pressure, or added accelerants. retardant(s) may comprise, for example, lignosulfonate and/or hydroxycarboxylic acids.

Embodiments may comprise between about 0.2% and about 2% fluid loss additive(s) by weight of concrete. Fuel loss additive(s) may comprise, for example, hydroxyethyl cellulose and/or carboxymethyl hydroxymethyl cellulose.

Embodiments may comprise between about 2% and about 25% extender(s) by weight of concrete, to reduce the column weight of the carbon negative cement and/or to decrease hydrostatic pressure. Extender(s) may comprise, for example, bentonite and/or sodium silicate.

Embodiments may comprise between about 1% and about 15% heavy weight additive(s) by weight of concrete, to increase the column weight of the carbon negative cement. Heavy weight additive(s) may comprise, for example, hematite and/or ilmenite

Embodiments may comprise between about 0.2% and about 3.2% permeability plugging additive(s) by weight of concrete, to reduce the rate of aqueous dispersion into permeable formations expressing positive differential pressure. Permeability plugging additive(s) may comprise, for example, styrene butadiene latex and/or polyvinyl acrylamide.

Embodiments may comprise between about 0.1% and about 11% macro plugging additive(s) by weight of concrete, to reduce the rate of their dispersion into fractures. Permeability plugging agent(s) may comprise, for example, nylon, cellophane, and/or gilsonite.

Embodiments may comprise between about 2.0% and about 5.5% expansion additive(s) by weight of concrete, to permit the set carbon negative cement to grow in surface area in the presence of down-hole liquids. Such expansion additive(s) may comprise, for example, Calcium oxide and/or Magnesium oxide.

Embodiments may comprise between about 0.1% and about 1.3% friction reducing additive(s) by weight of concrete, to improve their rates of flow. Such friction reducing additive(s) may comprise, for example, polynapthalene sulfonate.

Embodiments may comprise between about 0.1% and about 0.3% anti-foaming additive(s) by weight of concrete, to inhibit issues with centrifugal pump air-locking during the preparation and mixing of the carbon negative cement. Such anti-foaming additive(s) may comprise, for example, polypropylene glycol and/or polyethylene glycol.

While the descriptions above relate to various formulations of the cementitious material consistent with the teachings herein, it should be understood that they represent only a limited, exemplary, sample of the possible embodiments of the carbon sequestering cementitious building material that is the subject of this disclosure. Accordingly, it should be understood that other embodiments, including but not limited to, embodiments having compositions and/or concentrations of their constituent components that are different from those discussed, are contemplated hereby. In particular, even though the expressions “in an embodiment”, “in one embodiment”, “in another embodiment”, and their like, are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of concrete formulations and systems known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the claims or claim elements presented in this application to invoke 35 U.S.C. 112(f) unless the words “means for” or “step for” are explicitly used in the particular claim.

We claim:

1. A cementitious material comprising:
Portland cement;
sand; and.
biochar.

2. The cementitious material of claim 1, said cementitious material being substantially free from calcium oxide.

3. The cementitious material of claim 1, wherein said cementitious material is carbon negative.

4. The cementitious material of claim 1, wherein the cementitious material comprises between 12.0% and 26.0% biochar by dry weight.

5. The cementitious material of claim 1, wherein the cementitious material further comprises between 38% and 48% aggregate by dry weight.

6. The cementitious material of claim 1, wherein the cementitious material further comprises between 0.1% and 3.0% graphene by dry weight.

7. The cementitious material of claim 1, wherein the cementitious material further comprises between 2% and 12% silica fume by dry weight.

8. The cementitious material of claim 1, wherein the cementitious material further comprises between 10% and 26% fly ash by dry weight.

9. The cementitious material of claim 1, wherein the cementitious material further comprises between 8% and 16% anhydrous calcium sulfate by dry weight.

10. The cementitious material of claim 1, wherein the cementitious material further comprises between 0.1% and 3.0% carbon nanotubes by dry weight.

11. The cementitious material of claim 1, wherein the cementitious material further comprises between 0.1% and 3.0% carbon fullerenes by dry weight.

12. The cementitious material of claim 11, wherein the carbon fullerenes comprise at least one of C-20 to C-54 fullerenes and C-70 to C-360 fullerenes.

13. The cementitious material of 1, wherein the cementitious material further comprises between 1.5% and 4.5% fibers by dry weight.

14. The cementitious material of claim 13, wherein the fibers comprise at least one of:
fiberglass;
bagasse;
steel;
glass;
polypropylene;
carbon fiber; and
Kevlar.

15. The cementitious material of claim 1, wherein the cementitious material further comprises between 2% and 5.5% calcium chloride by weight.

16. The cementitious material of claim 16, wherein the calcium chloride is anhydrous.

17. The cementitious material of claim 1, wherein the cementitious material further comprises between 2% and 2.5% sodium chloride by weight.

18. The cementitious material of claim 1, wherein the cementitious material further comprises between 0.1% and 1% of a retardant by weight.

19. The cementitious material of claim 18, wherein the retardant comprises at least one of:
lignosulfonate; and
a hydrocarboxylic acid.

20. The cementitious material of claim 1, wherein the cementitious material further comprises between 0.2% and 2% of a fuel loss additive weight.

21. The cementitious material of claim 20, wherein the fuel loss additive comprises at least one of:
hydroxyethyl cellulose; and
carboxymethyl hydroxymethyl cellulose.

22. The cementitious material of claim 1, wherein the cementitious material further comprises between 2% and 25% of an extender by weight.

23. The cementitious material of claim 21, wherein the extender comprises at least one of:
bentonite; and
sodium silicate.

24. The cementitious material of claim 1, wherein the cementitious material further comprises between 1% and 15% of a heavy weight additive by weight.

25. The cementitious material of claim 24, wherein the heavy weight additive comprises at least one of:
hematite; and
ilmenite.

26. The cementitious material of claim 1, wherein the cementitious material further comprises between 0.2% and 3.2% of a permeability plugging additive by weight.

27. The cementitious material of claim 26, wherein the permeability plugging additive comprises at least one of:
butadiene latex; and
polyvinyl acrylamide.

28. The cementitious material of claim 1, wherein the cementitious material further comprises between 0.1% and 11.0% of a macro plugging additive by weight.

29. The cementitious material of claim 28, wherein the macro plugging additive comprises at least one of:
nylon;
cellophane; and
gilsonite.

30. The cementitious material of claim 1, f wherein the cementitious material further comprises between 2% and 5.5% of an expansion additive by weight.

31. The cementitious material of claim 30, wherein the expansion additive comprises at least one of:
calcium oxide; and
magnesium oxide.

32. The cementitious material of claim 1, wherein the cementitious material further comprises between 0.1% and 1.3% of a friction reducing additive by weight.

33. The cementitious material of claim 32, wherein the friction reducing additive comprises a polynapthalene sulfonate.

34. The cementitious material of claim 1, herein the cementitious material further comprises between 0.1% and 0.3% of an anti-foaming additive by weight.

35. The cementitious material of claim 34, wherein the anti-foaming additive comprises at least one of:
polypropylene glycol; and
polyethylene glycol.

36. The method of plugging a well comprising the steps of:
a. pumping a carbon-negative cementitious material into a well.

37. The method of claim 36, wherein the carbon-negative cementitious material comprises between 12% and 26% biochar by weight.
